(19) United States
(12) Patent Application Publication
(10) Pub. No.: US 2026/0269895 A1
(43) Pub. Date: Sep. 10, 2026

(54) System and Method for Integrated Millimeter-Wave Communication and Sensing Using Adaptive Beamforming

(71) Applicant: Mitsubishi Electric Research Laboratories, Inc., Cambridge, MA (US)

(72) Inventors: Pu Wang, Cambridge, MA (US); Kareem Attiah, Toronto (CA); Hassan Mansour, Newton, MA (US); Toshiaki Koike-Akino, Framingham, MA (US); Petros Boufounos, Winchester, MA (US)

(21) Appl. No.: 19/069,304

(22) Filed: Mar. 4, 2025

(51) Int. Cl. H04B 7/06; H04B 17/309

(52) U.S. Cl. CPC H04B 7/0617; H04B 17/346

(57) ABSTRACT

A system for integrated millimeter-wave (mmWave) communication and sensing is disclosed. The system includes an antenna array configured to transmit and receive directional signals via multiple available RF chains, a memory storing a predefined codebook of beamforming patterns, and a processor executing instructions to optimize beamforming for both communication and sensing. During beam training intervals, the system transmits and receives beamforming patterns from the codebook, computing beamforming qualities for devices in communication. The system then selects multiple beamforming patterns that meet a communication criterion, such as a minimum data transmission threshold. The system further determines weights for a linear combination of the selected beamforming patterns to optimize sensing performance while maintaining communication reliability. The antenna array is configured to use the optimized beamforming pattern, ensuring efficient integrated operation within power and hardware constraints.

### TECHNICAL FIELD

This disclosure relates to wireless communication and sensing systems, and more particularly to methods and systems for integrating communication and sensing functionalities in millimeter-wave (mmWave) networks by employing adaptive beamforming techniques. Specifically, the disclosure exploits prior knowledge from codebook beam training conducted during preceding beam training intervals (e.g., beacon transmission intervals (BTIs) and association beamforming training (A-BFT) intervals for 802.11ad/ay mmWave Wi-Fi), and involves leveraging suboptimal beamforming patterns that meet communication requirements to enhance sensing performance through dynamic optimization processes at subsequent data transmission intervals (e.g., DTI as defined in 802.11ad/ay mmWave Wi-Fi). Applications of this technology include smart home systems, building systems, indoor navigation and positioning, automotive applications such as in-cabin sensing, industrial automation, and other environments requiring simultaneous communication and environmental sensing capabilities.

### BACKGROUND

The evolution of wireless communication standards, such as IEEE 802.11f, reflects the growing interest in leveraging existing Wi-Fi infrastructure for applications beyond traditional data transmission. The IEEE 802.11bf standard introduces Wi-Fi sensing capabilities, enabling functionalities such as presence detection, object positioning, and object tracking. These advancements aim to repurpose Wi-Fi systems for dual functionalities, providing efficiencies in cost and hardware use. However, enabling communication and sensing within a single system introduces significant technical challenges.

Beamforming is a fundamental technology for high-frequency millimeter-wave (mmWave) Wi-Fi communication systems, such as those operating above 45 GHz, e.g., 802.11ad and ay standards. By directing signal energy toward specific spatial regions, beamforming overcomes the inherent path loss of mmWave frequencies, ensuring reliable data transmission. At the same time, beamforming, in some embodiments, can influence how signals interact with the environment, making beamforming a critical component for enabling sensing. While this dual potential is promising, the design and optimization of beamforming patterns that can serve both communication and sensing purposes remains complex and resource-intensive.

In the IEEE 802.11bf standards, these mmWave Wi-Fi systems are referred to directional multi-gigabit (DMG) Wi-Fi sensing operating at frequencies above 45 GH. DMG Wi-Fi sensing inherits DMG Wi-Fi communication mechanisms such as beacon training intervals (BTI) during which each device evaluates the transmit and receive channel qualities from and to the access point (AP) and data training intervals (DTI), during which devices can communicate both ways (downlink and uplink) with the AP using identified beam patterns from the BTI and, optionally, refine beamforming performance via exchange feedback. These mechanisms prioritize communication reliability, leaving open questions about how sensing functionalities can be seamlessly integrated without compromising communication performance. As a result, current approaches lack a systematic way to design beamforming patterns that support both functionalities effectively.

Additionally, practical constraints such as limited radio frequency (RF) chains and computational resources in mmWave Wi-Fi systems exacerbate the challenge. These limitations restrict the number of beamforming patterns that can be evaluated and applied in real-time, further complicating the task of balancing communication and sensing within the same system.

The need to address these challenges has become increasingly urgent as the demand for multi-functional wireless systems grows. While the IEEE 802.11bf standard provides a foundation, achieving seamless integration of communication and sensing functionalities within its framework and addressing the associated hardware constraints remains a significant technical problem requiring innovative solutions.

### SUMMARY

Some embodiments are based on the recognition that a beamforming pattern does not need to be optimal for communication purposes. Even a suboptimal pattern can be sufficient, as long as the suboptimal pattern meets the minimum communication requirements. Moreover, a suboptimal beamforming pattern that satisfies these requirements is adequate to simultaneously enable and enhance sensing performance. In other words, the communication pattern can be deliberately designed to be suboptimal yet adequate, as long as the communication pattern contributes to improved sensing performance.

This realization allows the system to allocate additional degrees of freedom in the beamforming design toward improving sensing objectives, such as spatial resolution, coverage, and motion detection. The trade-off is addressed by introducing a method to balance communication and sensing within a constrained hardware environment, such as, the limited number of RF chains, achieving robust integrated functionality.

The system begins by leveraging a predefined codebook containing multiple beamforming patterns. These patterns are evaluated in two stages. First, the system ensures that the selected patterns satisfy a minimum communication signal-to-noise ratio (SNR) requirement, a critical hard constraint to maintain reliable data transmission to and from discovered and paired user devices. In the second stage, the selected patterns are optimized and linearly combined to meet one or more sensing criteria, such as minimizing array response mismatch, maximizing coverage, reducing side lobe interference, or maximizing the probability of detection for a given probability of false alarm.

This dual-pronged approach, supported by iterative refinement processes such as alternating optimization, dynamically adjusts beamforming weights and auxiliary phase matrices to align the actual beam pattern with the desired response. For example, the desired response includes a form of unit array responses over a region of interests covering angles, distance, velocity, or combined dimensions. As a result, the system achieves a technical effect of balancing communication reliability with enhanced sensing performance, ensuring efficient resource utilization even under dynamic environmental conditions.

Accordingly, one embodiment discloses a system for integrated mmWave communication and sensing. The system includes an antenna array configured to transmit and receive directional signals via a number of available RF chains. The system also includes a memory configured to store a predefined codebook comprising a plurality of beamforming weights, each corresponding to a transmitting or receiving beamforming pattern. The system further includes a processor coupled with instruction stored in the memory that, when executed by the processor, cause the system to send and receive beamforming patterns from the codebook during beam training intervals, and compute beamforming qualities for one or multiple devices in communication with the system. The processor causes the system to select multiple beamforming patterns from the codebook according to the number of available RF chains having the beamforming qualities sufficient to satisfy a communication criterion including a minimum data transmission threshold for communication with the devices. The processor further causes the system to determine weights for a linear combination of the selected beamforming patterns optimized for a sensing criterion while maintaining the communication criterion to produce an optimized beamforming pattern. Moreover, the processor causes the system to configure the antenna array to utilize the optimized beamforming pattern for integrated communication and sensing while adhering to power and hardware constraints.

Another embodiment discloses a method for integrated mmWave communication and sensing. The method uses a processor coupled with stored instructions implementing the method, wherein the instructions, when executed by the processor carry out steps of the method. The steps of the method include sending and receiving beamforming patterns from a codebook of beamforming patterns during beam training intervals and computing beamforming qualities for one or more devices in communication with the system. The steps also include selecting multiple beamforming patterns from the codebook based on a number of available RF chains and the beamforming qualities. The selected patterns satisfy a communication criterion including a minimum data transmission threshold for communication with the devices. The steps further include determining weights for a linear combination of the selected beamforming patterns, the linear combination being optimized for a sensing criterion while maintaining the communication criterion. Moreover, the steps include producing an optimized beamforming pattern based on the linear combination. The steps also include performing integrated communication and sensing using an antenna array configured to utilize the optimized beamforming pattern.

Yet another embodiment discloses a non-transitory computer-readable storage medium embodied thereon a program executable by a processor for performing a method for perceiving an object in a scene. The method includes sending and receiving beamforming patterns from a codebook of beamforming patterns during beam training intervals and computing beamforming qualities for one or more devices in communication with the system. The method further includes selecting multiple beamforming patterns from the codebook based on a number of available RF chains and the beamforming qualities. The selected patterns satisfy a communication criterion including a minimum data transmission threshold for communication with the devices. Furthermore, the method includes determining weights for a linear combination of the selected beamforming patterns, the linear combination is optimized for a sensing criterion while maintaining the communication criterion. Moreover, the method includes producing an optimized beamforming pattern based on the linear combination. The method also includes performing integrated communication and sensing using an antenna array configured to utilize the optimized beamforming pattern.

### BRIEF DESCRIPTION OF THE DRAWINGS

The presently disclosed embodiments are further explained with reference to the attached drawings. The drawings shown are not necessarily to scale, with emphasis instead generally being placed upon illustrating the principles of the presently disclosed embodiments.

FIG. 1 illustrates a schematic of an environment diagram of a system for DMG sensing with multidirectional mmWave Wi-Fi data transmissions, according to an embodiment of the present disclosure.

FIG. 2 illustrates a block diagram of the system for DMG sensing with multidirectional mmWave Wi-Fi beacon transmissions, according to some embodiments of the present disclosure.

FIG. 3A illustrates a system architecture for integrated communication and sensing using adaptive beamforming, in accordance with some embodiments.

FIG. 3B provides a functional flow of the beamforming pattern selection and optimization process, in accordance with some embodiments.

FIG. 4A schematically illustrates a relationship between communication and sensing, according to an embodiment of the present disclosure.

FIG. 4B illustrates a frame structure of a data frame transmitted by the AP.

FIG. 4C illustrates different phases in a schedule of multi-directional mmWave Wi-Fi beacon and data transmission intervals, according to an embodiment of the present disclosure.

FIG. 5A illustrates a schematic diagram of a process of information exchange between an access point (AP), such as the AP, and a station (STA), such as the STA as per a process of a DMG sensing session, according to an embodiment of the present disclosure.

FIG. 5B illustrates example of inter-packet measurements and intra-packet measurements, in accordance with an embodiment of the present disclosure.

FIG. 6 shows a schematic of a two-stage beamforming optimization process employed by some embodiment to balance communication and sensing objectives.

FIG. 7 shows a block diagram of exemplar implementation of the two-stage beamforming process according to some embodiments.

FIG. 8A illustrates the two-way matching pursuit for codeword selection, in accordance with some embodiments, which correspond to Stage 1 of the beamforming selection process.

FIG. 8B shows a pseudocode for exemplar implementation of the two-way matching pursuit method of FIG. 8A, in accordance with some embodiments.

FIG. 9A illustrates the refinement process of beamforming weights and auxiliary phase matrix using an alternating optimization, in accordance with some embodiments.

FIG. 9B shows mathematical formulation of alternating optimization used by some embodiments.

FIG. 10 illustrates a block diagram of a computing system for implementing the DMG sensing, according to an embodiment of the present disclosure.

### DETAILED DESCRIPTION

### Overview of the Contribution to the Art

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN. WLAN sensing or Wi-Fi sensing generally refers to a WLAN in which one or more WLAN devices monitor or map the environment using standard WLAN signals. For example, a Wi-Fi sensing system may use the signal reflections off walls or other objects, including people, to map and measure the environment, and to identify and track objects within that environment.

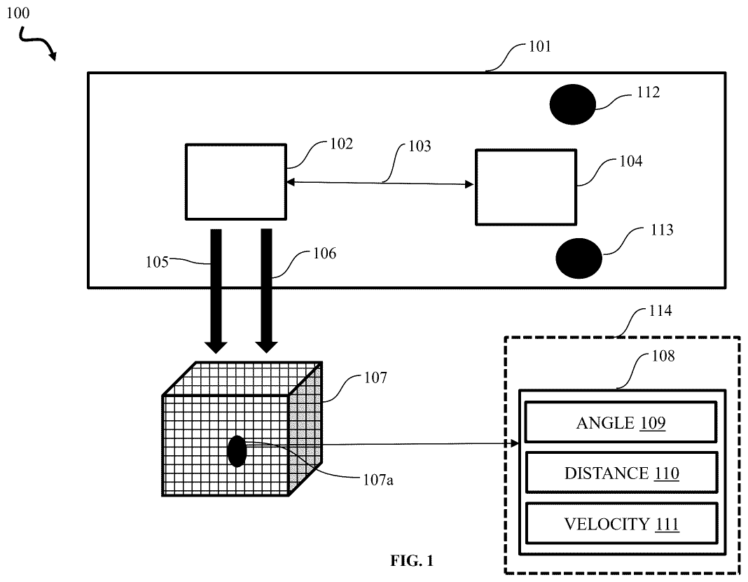

FIG. 1 illustrates a schematic of an environment diagram 100 of a system 102 for DMG sensing with multidirectional mmWave Wi-Fi beacon transmissions, according to an embodiment of the present disclosure. The environment diagram 100 includes an environment 101 and one or more systems or devices—such as a system 102 and a system 104. Each of the one or more systems may be any of—a transmitter, a receiver, an AP, an STA, a wireless communication terminal, a mobile device, a wireless communication routing terminal, and the like. The environment 101 also includes one or more objects, such as an object 112, and an object 113.

The one or more objects may be any of static objects, permanently static objects, intermittently static objects, moving objects, and the like. One of the one or more objects may be an object-of-interest, for which object detection may need to be performed in the environment 101. For example, the object 112 may be the object-of-interest in the environment, which may need to be detected and localized.

In an embodiment, the environment 101 may be an indoor environment, such as a room, a parking lot, a mall, a shop, a clinic, a human care facility, and the like. The detection of the object-of-interest may be done to perform any of one or more of activities such as gesture recognition, movement monitoring, fall detection, vital signs monitoring, elder care, remote troubleshooting, home automation and monitoring, tracking and surveillance, industrial automation monitoring, and the like.

The detection of the object may be done using DMG sensing with mmWave Wi-Fi beacon transmissions. Any of the one or more systems—the system 102 and the system 104 may be used to perform the DMG sensing described herein. For brevity of explanation, the operation of various embodiments would be described to be performed by the system 102 for the sake of example. However, such a description should not be construed as a limitation on the scope of the present disclosure, as may be understood by those of ordinary skill in the art.

In some embodiments, the system 102 is configured to collect a schedule 103 of the multidirectional mmWave Wi-Fi beacon transmissions including times and directional sector of each mmWave packet in the directional beam training. The system 102 is further configured to statistically evaluate values of an occupancy map 107 of the environment 101 using a model 114 connecting the schedule 103 of the beacon transmissions with: intra-packet measurements 105 and inter-packet measurements 106 of reflections of the multidirectional mmWave Wi-Fi beacon transmissions. The occupancy map 107 is used for determining parameters 108 of the object 112 in the environment 101 based on values 107a of the occupancy map 107. The parameters 108 of the object 112 include a velocity 111 of the object 112, a distance 110 of/to the object, and an angle 109 of the object 112 wherein the angle 109 further comprises an azimuth and an elevation. Once the parameters 108 of the object 112 are detected, they may be output for further application. For example, the parameters 108 of the detected object may then be used for localizing the object 112. For example, the system 102 may include an output interface which may be used to display the parameters 108 of the object 112.

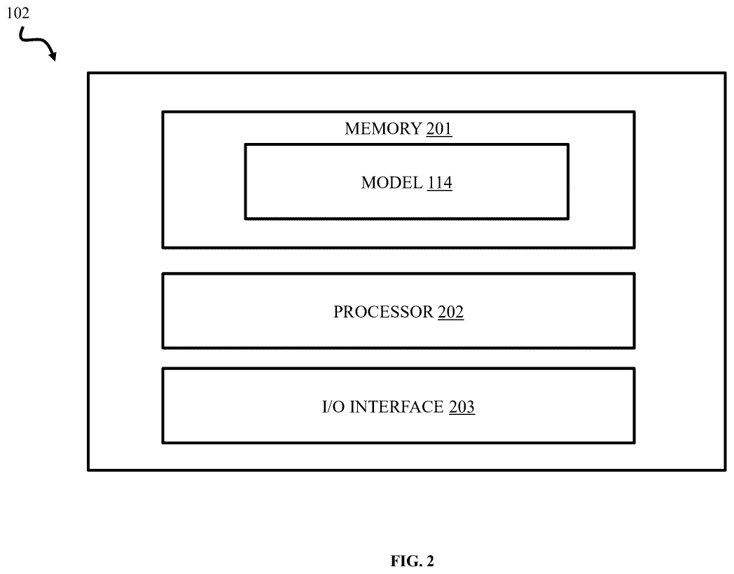

FIG. 2 illustrates a block diagram of the system 102 for DMG sensing with multidirectional mmWave Wi-Fi beacon transmissions, according to some embodiments of the present disclosure. The system 102 includes a memory 201, a processor 202, and an input-output (I/O) interface 203. The system 102 may include fewer or more components, and the illustration of FIG. 2 is used for the purpose of explanation only, without limiting the scope of the present disclosure.

The memory 201 may store instructions, such as computer program instructions, which are executable by the processor 202 to conduct the operations of the system 102 described herein. The memory 201 may also store the model 114, which may be a joint signal model to model jointly the different parameters of the object-of-interest. Further the system comprises the I/O interface 203 which may be used to output the detected parameters of the detected object or the object-of-interest, such on a display interface. The system 102 collects the intra-packet measurements 105 and the inter-packet measurements106 of reflections of the multidirectional mmWave Wi-Fi beacon transmissions within the environment 101. The system 102 uses the collected intra-packet measurements 105 and the inter-packet measurements106 to then detect the object, such as the object 112 or the object 113, in the environment. To that end, the system 102 may be configured as a sensing devise to collect the intra-packet measurements 105 and the inter-packet measurements106 and detect the object 112. In this example, the system 104 may be configured as the transmitter transmitting one or more beacons and the schedule 103 of the multidirectional mmWave Wi-Fi beacon transmissions including times and directional sector of each mmWave packet in the directional beam training.

In an alternate embodiment, the system 102 may be configured as the transmitter transmitting one or more beacons and the schedule 103 of the multidirectional mmWave Wi-Fi beacon transmissions including times and directional sector of each mmWave packet in the directional beam training, while the system 104 is configured as the sensing device to collect the intra-packet measurements 105 and the inter-packet measurements106 and detect the object 112. The sensing device may be configured to detect the object using DMG sensing with multidirectional mmWave Wi-Fi beacon transmissions.

### Overview of Adaptive Beamforming

The integration of communication and sensing in millimeter-wave (mmWave) Wi-Fi systems requires addressing inherent trade-offs between these two objectives. Communication prioritizes achieving high signal-to-noise ratios (SNR) for reliable data transmission, while sensing focuses on spatial resolution and accuracy for object detection and localization. A significant realization underlying the proposed system is that a suboptimal beamforming pattern for communication can still meet minimum communication requirements and simultaneously enhance sensing performance. This realization enables the system to allocate resources more effectively, balancing communication and sensing objectives.

In this context, “suboptimal” refers to a beamforming pattern that does not maximize communication SNR but still satisfies a baseline SNR threshold necessary for reliable communication. Once this threshold is met, the remaining degrees of freedom in the beamforming design can be directed toward improving sensing performance. For example, one embodiment may utilize suboptimal communication patterns to minimize antenna mismatch, enhancing the alignment between the desired and actual sensing beam patterns. By reducing this mismatch, the system improves its ability to detect and localize objects in the environment.

The improvement of sensing performance depends on the specific application and can be guided by various criteria. One approach is maximizing sensing coverage by optimizing beamforming patterns to extend the angular range, ensuring the system can detect objects across a wider field of view. In scenarios requiring greater spatial precision, enhancing angular resolution becomes essential, allowing the system to distinguish between closely spaced objects more effectively.

Another possible consideration is suppressing side lobe interference, which helps minimize unwanted signals and enhances clarity by focusing energy on target regions. Additionally, improving sensitivity to motion can be achieved by adapting beamforming patterns to detect Doppler shifts, making it easier to track moving objects.

In some applications, focusing on priority areas is beneficial. In such a case, the system allocates beamforming resources to regions of interest, such as areas with high object densities or challenging environmental conditions, ensuring that critical targets are accurately detected. Through these tailored optimizations, sensing systems achieve superior performance across diverse operational environments.

One embodiment involves selecting beamforming patterns from a predefined codebook. This approach ensures that the selected pattern satisfies communication requirements while allowing flexibility in optimizing sensing performance. Another embodiment includes iterative refinement of the beamforming pattern using feedback from sensing or communication data. For example, the system starts with a pattern that meets the SNR threshold for communication and iteratively adjusts the pattern to minimize mismatch or maximize sensing coverage.

Adaptive beamforming techniques further enable the system to manage communication and sensing trade-offs dynamically. For instance, in one embodiment, the system employs a two-stage optimization process. In the first stage, the system selects beamforming patterns that meet the communication threshold while being conducive to sensing objectives. In the second stage, the system refines the beamforming weights to further enhance sensing performance based on criteria such as reducing mismatch or expanding coverage. These adjustments are made while respecting hardware constraints, such as power limits or the number of available RF chains.

In environments where conditions change rapidly, such as those with moving objects or varying interference levels, the ability to use suboptimal communication patterns to improve sensing provides a significant advantage. By dynamically adapting to these changes, the system maintains reliable communication while optimizing sensing performance. This realization opens the door to a wide range of applications, including automotive radar, smart home systems, and industrial automation, where robust and adaptive performance is essential.

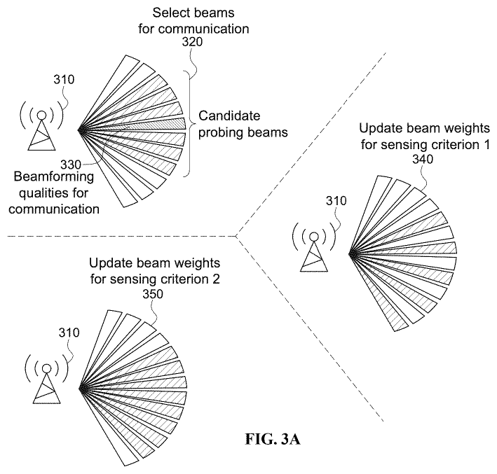

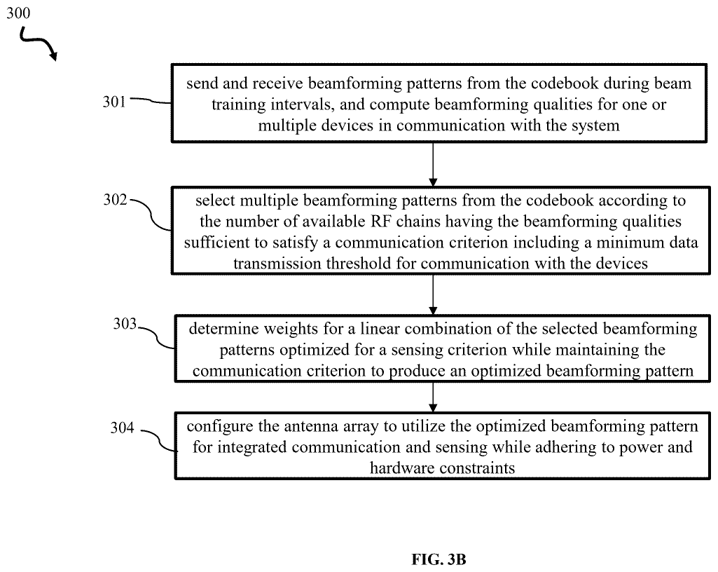

FIG. 3A illustrates a system architecture for integrated communication and sensing using adaptive beamforming, in accordance with some embodiments. During the beamforming training stage, the system evaluates multiple beamforming patterns (320) from a predefined codebook to determine associated beamforming qualities for communication purposes. Based on this evaluation, the system selects a primary communication beam (330) that satisfies the minimum communication signal-to-noise ratio (SNR) and other performance metrics.

Considering the number of available radio frequency (RF) chains 310, the system can assign different weights to the selected beamforming patterns, forming a linear combination of these patterns to optimize communication performance. Specifically, instead of relying on a single beam, the system superimposes multiple beams from the codebook with carefully chosen weights, effectively shaping the final transmission pattern to meet communication constraints while maintaining flexibility for sensing.

Armed with this understanding, the system can further update the beamforming weights to optimize for different sensing objectives or criteria. For example, if the system updates the weights according to a first sensing criterion, the resulting final beam pattern (340) may be optimized for maximizing angular resolution. Alternatively, if the system updates the weights according to a second sensing criterion, the final beam pattern (350) may be configured to suppress side-lobe interference or enhance coverage over a broader angular range. This dynamic weight adjustment allows the system to achieve an optimal trade-off between communication reliability and sensing accuracy, ensuring efficient operation in diverse environments. The final beam pattern 340 and 350 may not necessarily have primary communication beam but are collectively good for communication.

FIG. 3B provides a functional flow of the beamforming pattern selection and optimization process 300, in accordance with some embodiments. In step 301, the system sends and receives beamforming patterns during beam training intervals, and computes beamforming qualities for one or more communication devices. In step 302, the system selects multiple beamforming patterns from the codebook, ensuring that the chosen patterns meet the communication criterion, such as a minimum data transmission threshold. In step 303, the system determines the weights for a linear combination of the selected beamforming patterns, optimizing the combined pattern according to a sensing criterion while maintaining the communication criterion and produce an optimized beamforming pattern. Finally, in step 304, the system configures the antenna array to apply the optimized beamforming pattern for integrated communication and sensing while adhering to power and hardware constraints.

### Directional Beam Training

Directional beam training is a fundamental process in mmWave communication systems, such as those defined in IEEE 802.11ad/ay and 5G NR, where an access point (AP) or base station transmits and receives signals using predefined beamforming patterns to identify the optimal communication link. This process occurs during beam training intervals, including the Beacon Transmission Interval (BTI) and Association Beamforming Training (A-BFT), where devices evaluate received signal strengths to determine the most effective beams for communication. By leveraging these standardized training procedures, the disclosed embodiments can opportunistically integrate sensing functionality without modifying mmWave protocols.

In particular, the system selects beamforming patterns from the existing codebook for communication and dynamically adjusts associated weights to optimize sensing performance while maintaining communication reliability. Since directional beams inherently interact with the environment, analyzing beam training feedback allows the system to extract sensing information, such as object presence, motion, or spatial positioning, without additional transmissions or protocol changes. By refining beam weights post-training, the system can generate different beam patterns tailored for specific sensing objectives, such as enhancing angular resolution or suppressing side-lobe interference. This approach ensures full compliance with mmWave standards while enabling efficient, hardware-compatible integration of communication and sensing functionalities.

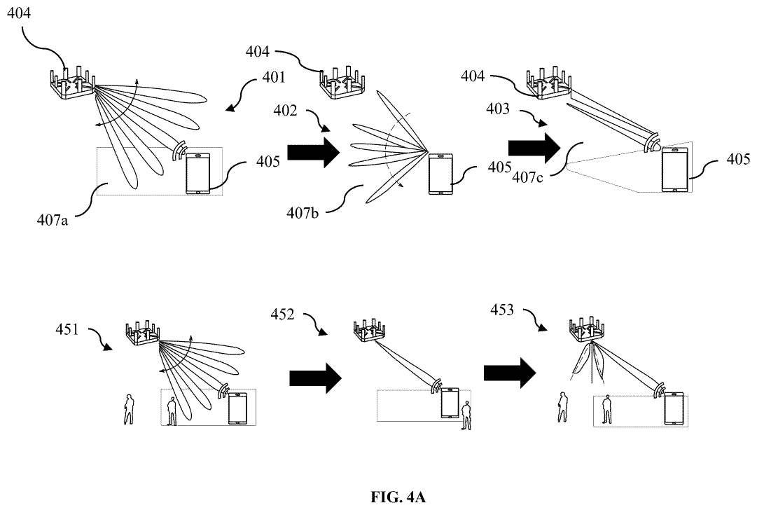

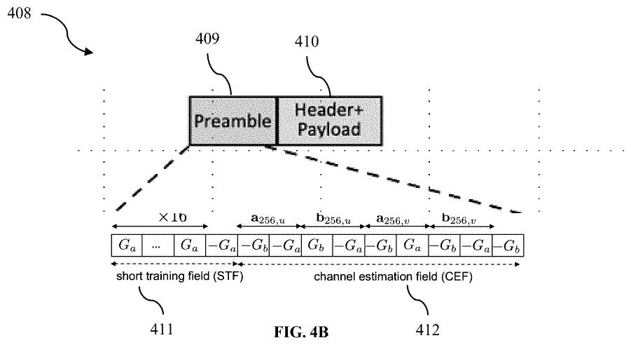

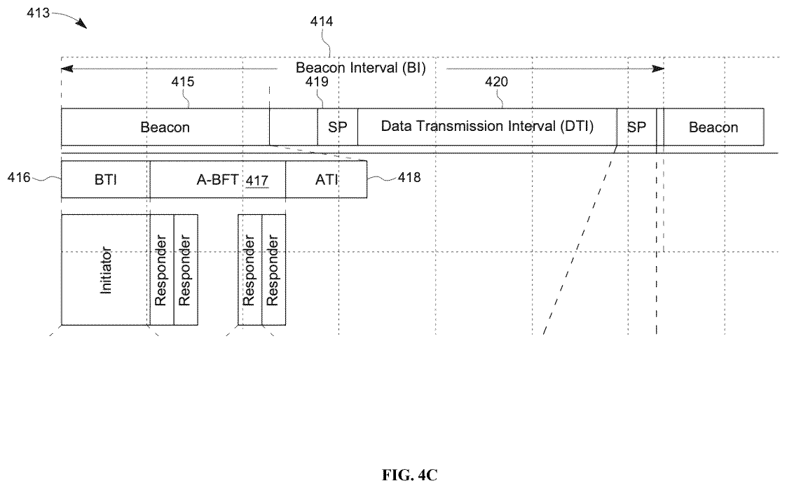

FIG. 4A schematically illustrates a relationship between communication and sensing according to an embodiment of the present disclosure. First three stages, for example, a first stage 401, a second stage 402, and a third stage 403, depicts various stages of communication, while the next three stages 451, 452, and 453 various stages of integrated DMG sensing. The stage 451 depicts a BTI sensing stage, the stage 452 depicts a DTI sensing using downlink beam, and stage 453 depicts DTI sensing where downlink beam is used to sense an STA, and additional beams are used to sense and track objects in the environment.

In the first stage 401, during directional beam training, an AP, such as the system 102 or the system 104 emits beacons to advertise their presence. For example, an AP 404 acts as a communication transmitter and transmits beacons 407a in different directions, which may be precepted by a STA 405, which acts as a communication receiver. It may be understood that any of the AP 404 and the STA 405 may be considered equivalent to the system 102 or the system 104 shown in FIG. 1. The objective of these beacons is to scan an environment with the AP 404, and the STA 405 listens in different directions and also perform scanning in different directions. The beacons are omni-directional and are transmitted from the AP 404 every 100 ms as per IEEE 802.11ad/ay communication standards.

In the second stage 402, the STA 405 performs beam scanning 407b in different directions, so that in the third stage 403, a best beam pair 407c is identified for communication between the AP 404 and the STA 405. The best beam pair 407c is identified using signal strength measurements calculated at the AP 404 side and the STA 405 and sending these as feedback during scanning in either direction.

Each beacon is transmitted in the form of a beacon frame, which is further illustrated in FIG. 4B.

FIG. 4B illustrates a frame structure of a beacon frame 408 transmitted by the AP 404. The beacon frame 408 comprises a preamble 409 field and a header and payload 410 field. The preamble 409 further comprises a short training field (STF) 411 and a channel estimation field (CEF) 412. The STF 411 is used for signal detection, timing, and coarse frequency correction. STF sequences are designed using a base binary sequence. For example, one STF might include the base binary sequence [−1, −1 −1 +1 +1 +1 −1, +1, +1 +1 −1 +1 +1 −1, +1]. The CEF 412 is used for fine frequency and channel estimation. The STF 411 and the CEF 412, in the embodiments, is provided in the form of Golay sequences. A Golay sequence is a pair of binary sequences with a nonperiodic autocorrelation function of zero. The Golay sequences are also known as Golay complementary sequences or Golay pairs. Golay sequences are often defined over an alphabet of size 2 (binary), 4 (quaternary), or 8 (octary). Golay sequences are characterized by the property that the sum of their aperiodic autocorrelation functions equals zero, except for the zero shift. As illustrated in FIG. 4B, Gₐ and G_{b} are Golay complementary sequences of length 128 bits. The beacon frames having the structure shown in FIG. 4B may be used to perform directional beam training in different phases as per a schedule of multi-directional mmWave Wi-Fi beacon transmissions, as shown in FIG. 4C.

FIG. 4C illustrates different phases in a schedule 413 of multi-directional mmWave Wi-Fi beacon transmissions, according to an embodiment of the present disclosure. The schedule 413 of the multi-directional mmWave Wi-Fi beacon transmissions includes different phases, such as a beacon transmission phase 415, a service period (SP) 419 phase, and a DTI 420 phase, which are periodically transmitted during a beacon interval 414. Each beacon interval may be 100 ms in an example.

The beacon phase 415 itself comprises three phases—a downlink phase which is a BTI phase 416, and an uplink phase which is an A-BFT phase 417, and an ATI phase 418. The BTI phase 416 includes multiple beacons or beacon frames transmitted by a communication initiator, such as an access point. The A-BFT phase 417 comprises multiple SSW frames transmitted by a communication responder, such as a STA.

During the DMG beam training initiated by the AP during the BTI phase 416 directional frames are transmitted over sector-level beampatterns to probe devices and environment over different angle sectors as shown in step 401 of FIG. 4A. During this phase, multiple users, in some embodiments, simultaneously compute own received beam SNRs corresponding to each of the transmitted beampatterns using a quasi-omnidirectional receiving beampattern and identify the respective best beam for downlink data transmission. In the subsequent A-BFT phase 417, the users, in some embodiments, train the (TX or RX) beampatterns by sending a sequence of (short) sector sweep (SSW) frames to the AP, as shown in 402 in FIG. 4A to identify the best beam for uplink data transmission. Data is then be exchanged in DTI phase 420, as shown in step 403 of FIG. 4A, with the best downlink and uplink beams that cover LOS path.

In an embodiment, the Golay sequence-based preamble 409 including short

training field (STF) 411 and channel estimation field (CEF) 412 is repurposed for DMG Wi-Fi sensing.

In an embodiment of the present disclosure, the DMG sensing reuses directional beacon frames during BTI phase 416 for object detection. In an embodiment of a monostatic setting, the AP 404 sends the same directional beacon frames during BTI phase and an additional sensing receiver is used at the AP 404 to capture the reflected beacon frames, or the reflections of the beacon frames from objects-of-interest and the environment. The frame-to-frame TX-RX antenna gain thus forms inter-packet measurements 106 (due to the misalignment between the probing beampatterns and the object steering vector) to the frame-based slow-time samples for Doppler steering vector. The joint TX-RX steering vector has a Kronecker structure between the range-domain steering vector (formed by the delayed preamble matched filter output) and the Doppler steering vector element-wise weighted by antenna

gains. Following that, rather than the sequential approach, the object detection is formulated as a binary hypothesis testing where both preamble and Doppler steering vector are utilized. Accordingly, the signal model 114 is generated, which uses a subspace-based object detector and a computational implementation of generalized likelihood ratio test (GLRT).

The schedule 413 comprises following steps—beacon phase 415, data transmission phase/interval 420, and a service period (SP) phase 419. Beacon is transmitted periodically, every 100 ms, in different directions. Direction is determined by the manufacturer of the transmitting system, such as the AP 404. So, beacon is broadcasted periodically in these different directions. If there are multiple devices, such as access points (APs) or stations (STA) in an environment, they need to know which direction the beacon is being transmitted in, for efficient communication exchange. However, that is not always the case. Currently, the devices, in some embodiments, receive the different beams of the beacon, calculate SNR at the device, and report back to the transmitter that indices of the best quality beam received by devices.

Further, during the BTI (downlink) phase 416, beacon frames by AP/PCP may be re-used for downlink sensing, and during A-BFT (uplink) phase 417, (short) sector sweep (SSW) frames by non-AP STA may be reused for uplink DMG sensing. In an embodiment, TRN sequences, in some embodiments, are added to beacon frames to enable STAs to sense in several directions to perform a process of a DMG sensing.

### DMG Sensing

Passive sensing refers to the system's ability to extract environmental information from existing communication signals without requiring dedicated sensing transmissions. Specifically, the system leverages the reflections and distortions of directional beams used during beam training and data transmission intervals to infer the presence, movement, and characteristics of objects within the sensing environment. This approach allows sensing functionality to be seamlessly integrated into standard mmWave communication procedures, such as those defined in IEEE 802.11ad/ay, without modifying the underlying protocol or requiring additional spectrum resources.

By analyzing variations in received signal strength, phase shifts, and Doppler effects across different beamforming patterns, the system performs DMG sensing to detect objects or track movement in the environment. Unlike active sensing methods that rely on separate radar-like transmissions, passive sensing in this system utilizes beam training feedback and existing communication signals to optimize beamforming weights dynamically. This enables efficient, low-overhead sensing capabilities that operate concurrently with communication, making it well-suited for applications such as smart home monitoring, indoor positioning, and automotive in-cabin sensing.

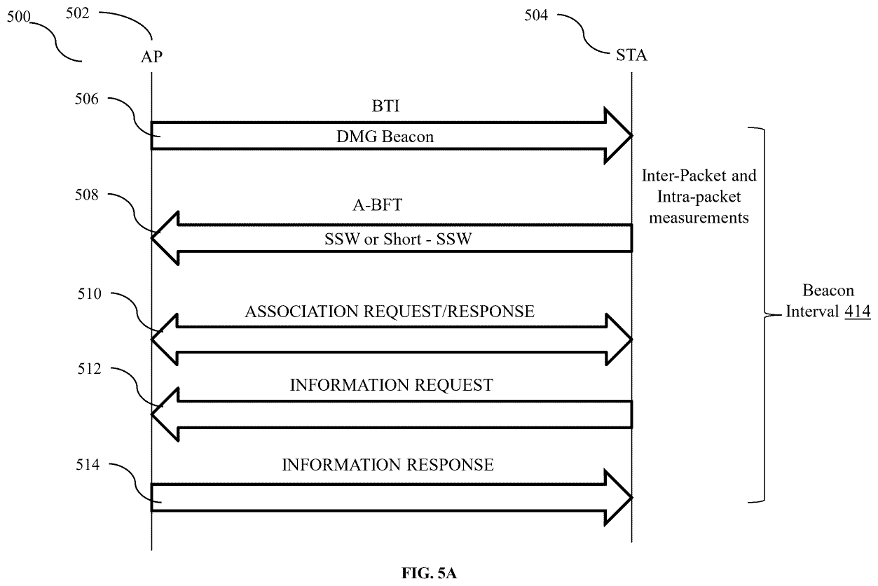

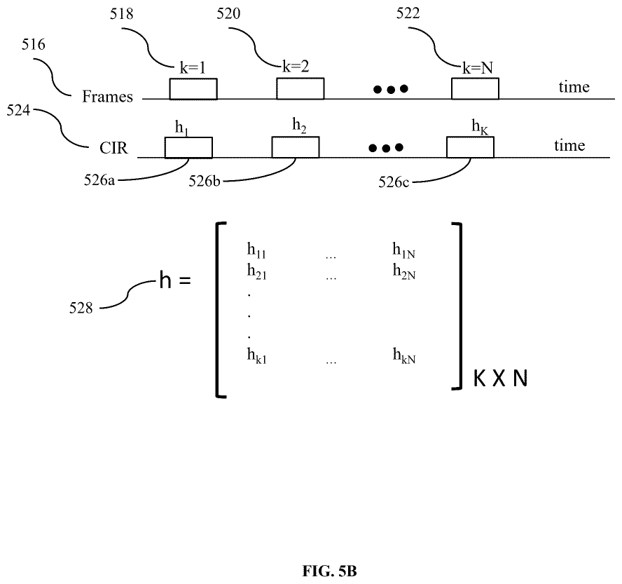

FIG. 5A illustrates a schematic diagram of a process 500 of information exchange between an access point (AP) 502, such as the AP 404, and a station (STA) 504, such as the STA 405 as per a process of a DMG sensing session, according to an embodiment of the present disclosure.

In the example process 500, at 506 the AP 502 transmits DMG beacon frames during the BTI phase. The DMG beacon frames form beacon transmissions which are transmitted as per a schedule of beacon transmissions, such as the schedule of beacon transmissions illustrated in FIG. 4C. The beacon frames are equivalently referred to as the beacon packets. The beacon packets are as per mmWave Wi-Fi beacon format defined by wireless communication standard IEEE 802.11ad/ay standard protocol. The beacon transmissions include the inter-packet and the intra-packet measurements. To that end, the AP 506 is scanning the environment 101 at all times and keeps transmitting multidirectional beacon packets of mmWave Wi-Fi beacon transmission format. When there are one or more objects in the environment 101, the beacon packets are reflected from these one or more objects and as a result the AP 502, which may also be the system 102, receives the reflections of the beacon packets. These reflections are used to determine the intra-packet measurements and the inter-packet measurements.

Some embodiments include the system 102 collecting the intra-packet measurements and the inter-packet measurements of reflections of the multidirectional mmWave Wi-Fi beacon transmissions within the environment 101. In some embodiments, the reflections are caused by an object-of-interest. The object-of-interest may be an object associated with the system 102 and is configured to be tracked or detected within the environment. Thus, the intra-packet measurements and the inter-packet measurements correspond to reflections of the multidirectional beacon transmissions caused by the object-of-interest.

FIG. 5B illustrates example of inter-packet measurements 516 and intra-packet measurements, in accordance with an embodiment of the present disclosure. The inter-packet measurements 516 include different frames or beacon frames for different indices k, such an inter-packet measurement 518 for k=1, an inter-packet measurement 520 for k=2, an inter-packet measurement 522 for k=K, and the like. Within each inter-packet measurement, there may be samples of multiple intra-packet measurements. For example, for k=1, there may be N samples of intra-packet measurements at different sampling intervals.

The measurements may correspond to different parameters of a signal received by the system 102, such as after reflection from the object 112 to be detected. For example, one type of measurement is a channel impulse response CIR 524. For the inter-packet measurement 518, the corresponding measurement value for CIR is h₁ 526a, for the inter-packet measurement 520, the corresponding measurement value for CIR is h₂ 526b, and for the inter-packet measurement 522, the corresponding measurement value for CIR is h_{K} 526c.

In some embodiments, h₁ is a vector of dimension 1×N, and overall value of the parameter h is represented as a vector 528 of dimension k×N, where each row includes N intra-packet measurements for an inter-packet measurement hₖ for the k-th row.

Some embodiments include the system 102 collecting the intra-packet measurements and the inter-packet measurements of permanently static objects caused by the multidirectional beacon transmissions. For example, if the environment 101 is a room, the permanently static objects include furniture in the room. To that end, the reflections of the multidirectional mmWave Wi-Fi beacon transmissions within the environment 101, by the furniture of the room are used to obtain the intra-packet measurements and the inter-packet measurements of the permanently static objects in the room.

Some embodiments include the system 102 collecting the intra-packet measurements and the inter-packet measurements of intermittently static objects in the environment 101. For example, if the environment 101 is a room, the intermittently static objects include, such as, a pet sleeping on a sofa. To that end, the reflections of the multidirectional mmWave Wi-Fi beacon transmissions within the environment 101, by the intermittently static objects are used to obtain the intra-packet measurements and the inter-packet measurements of the intermittently static object in the room.

In some embodiments, the measurements of the permanently static objects and the intermittently static objects form knowledge of the permanently static objects and intermittently static objects. This knowledge is used by the system 102 for detecting the object-of-interest, such as using the signal model 114. Also, as the beacon transmissions keep occurring periodically, the knowledge of the permanently static objects and intermittently static objects keeps getting updated. In some embodiments, the knowledge is updated when the object-of-interest is not within the environment 101. This knowledge thus forms background representation of objects for the signal model 114. The inter-packet measurements and the intra-packet measurements are further explained in FIG. 5B.

At 508, the STA 504 transmits SSW frames or short-SSW frames during the A-BFT phase 417 of the beacon interval 414. The AP 502 wants to sense the environment 101, so the AP 502 uses the SSW frames of the short-SSW frames to perform sensing of the environment 101.

In some embodiments, the AP 502 uses one bit in a DMG capabilities element to indicate that it supports sensing.

At 510, An association request/response is then exchanged between the STA 504 and the AP 502. The association request/response includes, for example, logging into a Wi-Fi device corresponding to the AP 502 and/or the STA 504 for authentication. In order for a sensing device, such as the system 101 to perform accurate sensing and correct interpretation of the inter-packet measurements and the intra-packet measurements, the sensing device needs to know in which direction the beacon frames were transmitted. Further, the sensing device needs to know the location of the AP 502 and it is also important that the beacon frames are transmitted at high time accuracy. However, it may be expensive to transmit all this information in the beacon frames due to large number of bits and low bit rate of the beacon frames.

Some embodiments are based on using an information request sent at 512, by the sensing device, which may be the STA 504 in the example of FIG. 5A to achieve the objectives described above in a less complex and less expensive manner. The STA 504 transmits the information request to the AP 502 to know the details of the location, the direction and the timing of the beacon transmissions.

To that end, the STA 504 requests information about a DMG beacon frame transmission from the AP 502 by sending an information request frame with an element ID of the DMG sensing beacon information element in the request element field.

### Exemplar Embodiments of Adaptive Beamforming for Joint Communication and Sensing

In mmWave communication systems, beam training intervals, including Beacon Transmission Intervals (BTI) and Association Beamforming Training (A-BFT) intervals, play a critical role in establishing high-quality communication links. During these intervals, the access point (AP) transmits directional beams from a predefined beamforming codebook, and the receiving device evaluates directional beams quality based on signal-to-noise ratio (SNR) and other performance metrics. The system uses this feedback to determine the most effective beamforming pattern for communication.

In this embodiment, the processor dynamically selects beamforming patterns based on the feedback obtained during these training intervals. Rather than simply choosing a single beam with the highest SNR, the system considers multiple candidate beam patterns and assigns optimized weights to form a linear combination of selected beams. This approach enhances communication reliability while maintaining flexibility for sensing operations. By leveraging the beam training feedback, the system ensures that the beam patterns used for sensing are inherently optimized for communication, eliminating the need for separate, dedicated sensing transmissions. This seamless integration allows the system to repurpose beam training data for environmental sensing, including object detection and motion tracking.

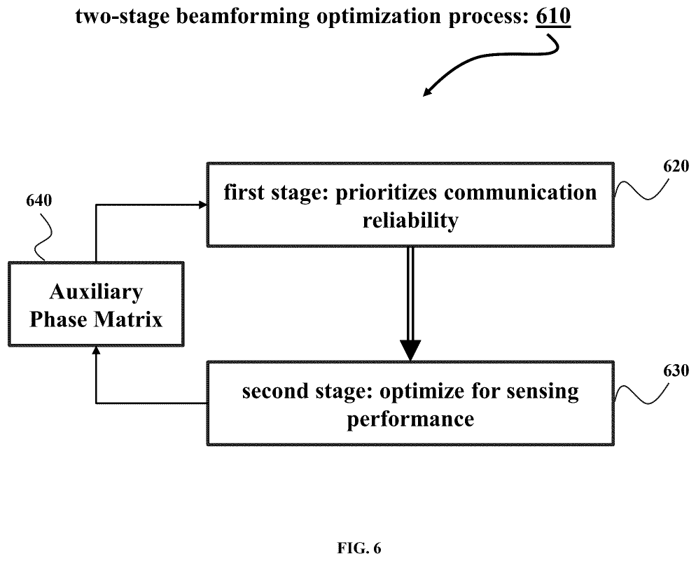

FIG. 6 shows a schematic of a two-stage beamforming optimization process 610 employed by some embodiments to balance communication and sensing objectives. The first stage 620 prioritizes communication reliability, ensuring that the selected beamforming patterns meet a predefined minimum SNR threshold for data transmission. This step ensures that communication performance remains uncompromised even when beamforming patterns are later adjusted for sensing.

Once the communication threshold is met, the second stage 630 refines the beamforming patterns to optimize for sensing performance based on one or more sensing criteria. The processor adjusts the beamforming weights to improve one or more of the following sensing objectives: maximizing sensing coverage for expanding the angular range to detect objects over a wider field of view; enhancing angular resolution for refining the beam shape to distinguish closely spaced objects; suppressing side-lobe interference for reducing unwanted secondary lobes in the beam pattern to improve signal clarity; and improving motion sensitivity for enhancing doppler shift sensitivity for improved object tracking. By iteratively refining the beamforming patterns, the system ensures that both communication and sensing functions operate optimally without requiring separate hardware or transmission resources.

Some embodiments employ auxiliary phase matrix adjustment for sensing objective during the second stage 630 of the two-stage beamforming optimization process 610. An auxiliary phase matrix 640 is introduced to enhance the alignment between the desired and actual sensing array response. This matrix acts as a correction factor, dynamically adjusting the phase shifts applied to the beamforming weights to ensure that the resulting array response matches the desired sensing characteristics.

The processor updates the auxiliary phase matrix based on real-time feedback from beam training or sensing measurements. For example, if the desired sensing response emphasizes high angular resolution, the system adjusts phase shifts to minimize phase errors across the antenna array. If the sensing objective prioritizes motion tracking, the auxiliary phase matrix modifies beam patterns to enhance Doppler sensitivity.

By incorporating this auxiliary phase adjustment, the system compensates for imperfections in the beamforming process, thereby improving the accuracy of object detection, localization, and tracking.

To that end, in some implementations, the system employing principle of adaptive beamforming, utilizes a hybrid beamforming architecture, which combines both analog and digital beamforming techniques to efficiently manage beamforming with a limited number of radio frequency (RF) chains. In fully digital beamforming, each antenna element requires a dedicated RF chain, leading to high hardware complexity and power consumption. The hybrid approach mitigates this issue by employing a smaller number of RF chains while still achieving the benefits of adaptive beamforming.

The hybrid beamforming architecture combines analog and digital beamforming to optimize communication and sensing performance while minimizing hardware complexity. In the analog beamforming stage, a limited set of RF phase shifters is used to generate an initial directional beam. The digital beamforming stage then refines the beam pattern by adjusting the weights of the selected beams through digital processing. Instead of generating unique beams for each transmission, the system employs a codebook-based approach, selecting and combining predefined beam patterns to ensure efficient hardware utilization. This hybrid strategy enables dynamic and adaptive beam control, allowing the system to balance communication and sensing objectives while maintaining a low-cost, power-efficient design. As a result, the hybrid strategy supports scalable deployment across various applications, including mmWave Wi-Fi, 5G networks, and automotive radar systems.

Two-Way Matching Pursuit with Subsequent Refinement

Some embodiments use the two-stage selection of the integrated communication and sensing system for millimeter-wave Wi-Fi networks. This is designed to efficiently balance communication and sensing objectives by leveraging a predefined codebook of beamforming patterns and optimizing their selection and refinement. These embodiments implement the two-stage optimization 610 using two-way matching pursuit with subsequent refinement approach.

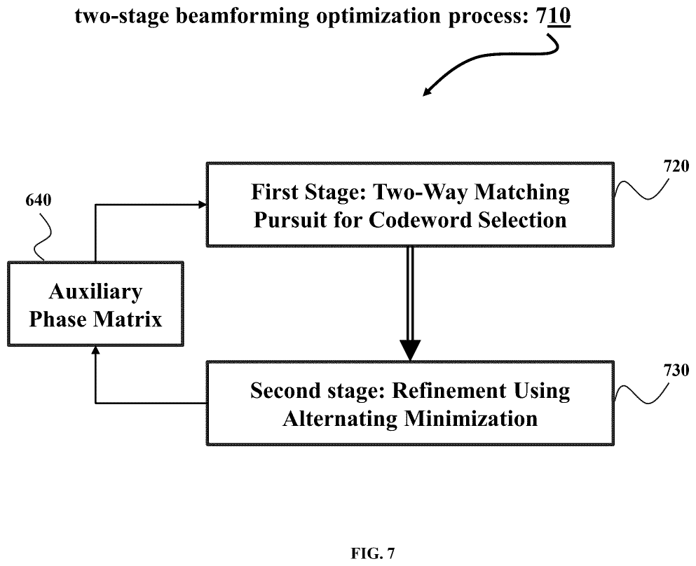

FIG. 7 shows a block diagram of exemplar implementation of the two-stage beamforming process 710 according to some embodiments. Each stage of the two-stage beamforming process 710 is implemented using a distinct approach to refine the selection and adaptation of beamforming patterns.

In the first stage, implemented by Two-Way Matching Pursuit (720), the system iteratively selects beamforming codewords from a predefined codebook, prioritizing communication reliability. The process ensures that the selected beams meet a minimum signal-to-noise ratio (SNR) threshold, balancing communication needs while preserving flexibility for sensing. This selection process also considers sensing performance by minimizing array response mismatch within the constraints of available RF chains.

In the second stage, implemented by Refinement Using Alternating Minimization (730), the selected codewords undergo further refinement to enhance sensing accuracy. This stage dynamically optimizes beamforming weights and adjusts an auxiliary phase matrix (640) to align the actual beamforming response with the desired sensing array response. The alternating minimization process iteratively updates the phase matrix and beamforming weights, improving spatial resolution, motion sensitivity, and object tracking accuracy.

By integrating Two-Way Matching Pursuit for selection and Alternating Minimization for refinement, the system efficiently adapts beam patterns for both communication and sensing, enabling precise environmental awareness without compromising data transmission quality. This dual-stage approach ensures scalable and hardware-efficient implementation in applications such as smart home automation, indoor positioning, and security monitoring.

### Stage 1: Two-Way Matching Pursuit for Codeword Selection

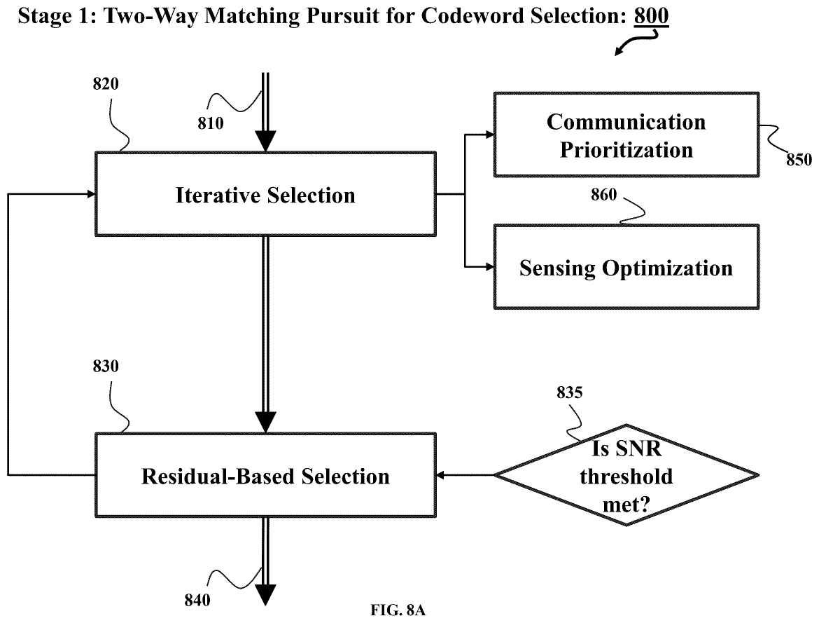

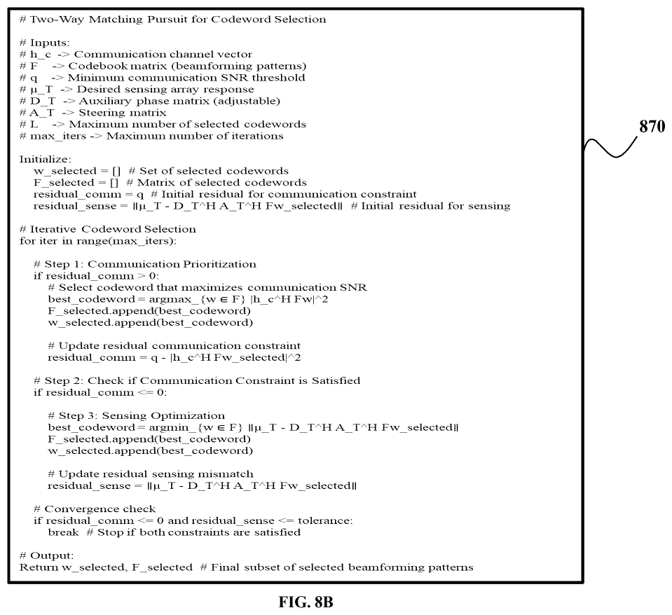

FIG. 8A illustrates the two-way matching pursuit for codeword selection 800, in accordance with some embodiments, which correspond to Stage 1 of the beamforming selection process. The first stage focuses on selecting multiple beamforming patterns (codewords) from the predefined codebook. This selection process ensures that the patterns satisfy communication requirements while also considering patterns potential to improve sensing performance.

The system starts at 810 by evaluating the communication SNR for each codeword in the codebook. The codewords are ranked based on associated ability to meet the communication SNR threshold, which is a “hard constraint” to ensure reliable communication.

Next, at 820, the codewords are iteratively selected using a two-way matching pursuit algorithm. The algorithm alternates between Communication Prioritization 850 and sensing optimization 860. For Communication Prioritization 850, the system selects codewords that maximize the communication SNR, especially when the current set of selected codewords does not yet satisfy the minimum communication threshold. After the communication SNR constraint is satisfied, the method shifts focus to sensing optimization 860 by selecting codewords that minimize the array response mismatch or meet other sensing criteria, such as maximizing sensing coverage or improving angular resolution.

At each step, the two-way matching pursuit method computes a residual term 830 which may have different objectives in dependence of meeting the communication constraint 835. For example, if the communication SNR threshold is not met, the residual represents the gap between the current communication performance and the desired threshold. Codewords are then selected to reduce this gap. Conversely, if the communication SNR threshold is met, the residual represents the mismatch between the desired and actual sensing array responses. Codewords are then selected to minimize this mismatch.

The result of the output 840 of Stage 1 is a subset of codewords that collectively satisfy the communication SNR constraint and are conducive to achieving sensing objectives.

FIG. 8B shows a pseudocode 870 for exemplar implementation of the two-way matching pursuit method of FIG. 8A, in accordance with some embodiments. Mathematically, for communication prioritization, the method selects beamforming patterns that satisfy the communication SNR constraint:

$${\vert {h}_{c}^{H} Fw \vert}^{2} \geq q$$

where h_{c} is the communication channel, F is the codebook matrix, w is the weight vector, and q is the minimum SNR.

After satisfying the communication SNR, the method minimizes the sensing array response mismatch:

$$‖ {μ}_{T} - {D}_{T}^{H} {A}_{T}^{H} Fw ‖$$

where μ_{T} is the desired array response, D_{T} is an auxiliary phase matrix, and

$${A}_{T}^{H}$$

is the steering matrix.

### Stage 2: Refinement Using Alternating Minimization

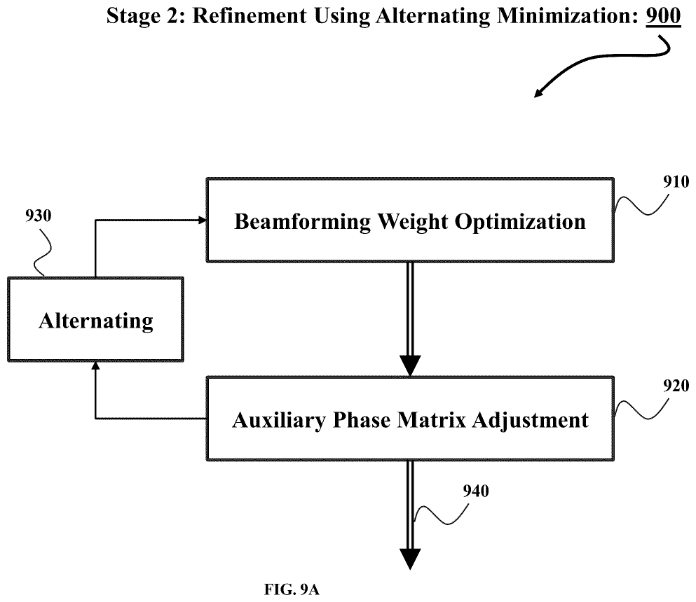

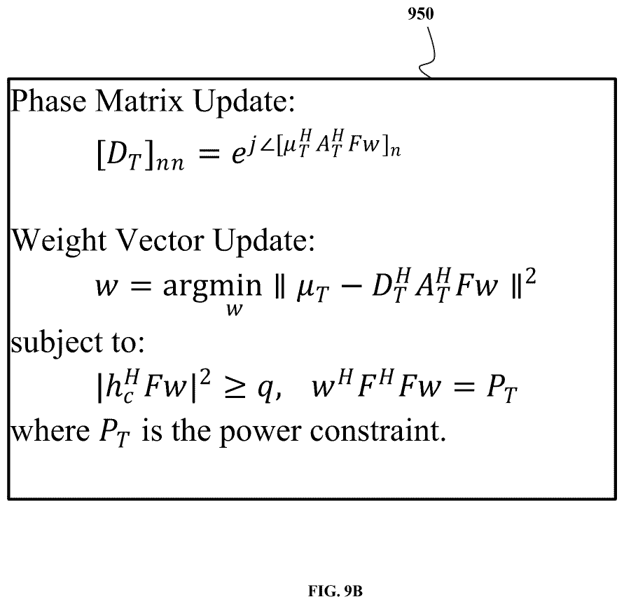

FIG. 9A illustrates the refinement process 900 of beamforming weights and auxiliary phase matrix using an alternating optimization, in accordance with some embodiments. This stage follows the initial Two-Way Matching Pursuit Codeword Selection and aims to further optimize the beamforming patterns for enhanced sensing performance while maintaining communication reliability.

The process begins, at 910, with determining the optimal weights for the selected beamforming codewords. These weights are computed to form the transmit beamforming vector, ensuring that the combined pattern meets the required communication SNR threshold while adhering to power constraints. This step guarantees that the beamforming configuration remains effective for data transmission.

Further, at 920, the sensing performance is improved by adjusting an auxiliary phase matrix. This auxiliary phase matrix is designed to adjust the phase components of the beamforming response, allowing for better alignment between the actual and desired sensing array responses. Through an iterative refinement process, the system minimizes the mismatch between these responses, ensuring accurate and robust sensing capabilities.

The optimization process follows an iterative alternating strategy 930, where the method switches between refining beamforming weights at 910 and adjusting the phase matrix 920. This approach continuously improves the sensing performance while maintaining the required communication quality. The iterations proceed until convergence is achieved, ensuring that the final beamforming pattern is optimized for both communication and sensing.

The output 940 of this process is an optimized beamforming vector that achieves a balanced trade-off between communication and sensing objectives. This optimized configuration satisfies power and hardware limitations, making it efficient for practical deployment in integrated communication and sensing systems. By dynamically adjusting the beamforming parameters, this optimization method ensures that the system effectively supports dual-functionality applications, such as wireless communication and environmental sensing, while maintaining high reliability and efficiency.

FIG. 9B shows mathematical formulation of alternating optimization 950 used by some embodiments. The two-stage process avoids the computational complexity of a brute-force search through all possible codeword combinations in the codebook. By separating communication and sensing priorities, the approach allows dynamic adaptation to varying environmental conditions and application requirements. The use of predefined codebooks and iterative optimization ensures that the method can scale to systems with large antenna arrays and limited RF chains.

### Exemplar Implementations

Assuming an additional sensing receiver (RX) is deployed at the AP in a monostatic configuration, this exemplar implementation discloses an integrated DTI communication and sensing scheme with adaptive beamforming to overcome the limitation that objects must be within the main beam of the trained downlink beam pattern. Specifically, some embodiments adopt a codebook beamforming approach that aims to match a desired array response over a given angle interval for object sensing, while adhering to power constraints, downlink communication SNR requirements, and limited RF chains. More importantly, this scheme does not require prior knowledge of the communication channel between the AP and users by leveraging downlink beam training during the BTI and the optional feedback mechanism during A-BFT. This is achieved by introducing a two-stage optimization. First, a two-way communication-sensing matching pursuit is introduced to select a set of codewords to be used by the AP to prioritize the communication link SNR and account for sensing performance. Then, given these selected codewords, an alternating minimization is employed between an auxiliary phase term and the beamforming weights to match a desired array response.

### Signal Model and Problem Formulation

The AP sends sector sweep (SSW) frames s_{g}(t) sequentially using directional beampatterns or codebook fₖ∈ [symbol] during BTI beam training to identify the best downlink beam to be used in DTI. Specifically, the SSW frame is given as

$${s}_{g} ( t ) = \sqrt{{E}_{s}} {\sum }_{l = 0}^{L - 1} {s}_{l} {g}_{T X} ( t - l {T}_{s} ) \qquad ( 1 )$$

where Eₛ is the symbol energy, sₗ is the modulated symbol after π/2-BPSK modulation with alphabet of {±1, ±i}, g_{TX}(t) is the baseband pulse (e.g., a pair of TX and RX filter for error vector magnitude measurement as a root-raised cosine (RRC) filter with a roll-off factor of 0.25), Tₛ=1/B is the symbol interval with B denoting the channel bandwidth, and L is the number of symbols.

Modulated with the carrier frequency f_{c} and weighted by the beamforming codebook fₖ, the k-th SSW frame is given as

$${x}_{k} ( t ) = {f}_{k} {s}_{g} ( t - k {T}_{p} ) {e}^{j 2 π {f}_{c} t} \qquad ( 2 )$$

where Tₚ is the pulse repetition interval (PRI). Assuming a geometric channel model with Nₛ scatterers between the AP and a user, the communication channel matrix is expressed as

$${H}_{comm} = {\sum }_{i = 1}^{{N}_{s}} {α}_{i} {a}_{R , comm} ( {θ}_{i} ) {a}_{T}^{H} ( {ϕ}_{i} ) , \qquad ( 3 )$$

where αᵢ represents the amplitude over the i-th path with θᵢ and φᵢ denoting associated angular angle-of-departure (AoD) and angle-of-arrival (AoA), and a_{R,comm} (θᵢ)∈ [symbol] and a_{T}(φᵢ)∈ [symbol] are, respectively, angular channel steering vectors.

On the user side, a pseudo-omni-directional receiving beampattern f_{comm}∈ [symbol] is employed for all K probing codewords. After applying carrier demodulation and a matched filter with respect to the baseband pulse g_{RX}(t) g_{TX}(t), the quality of each probing codeword can be calculated as

$${η}_{k} = {f}_{comm}^{H} {H}_{comm} {f}_{k} \sqrt{{E}_{s}} {\sum }_{l = 0}^{L - 1} {\vert {s}_{l} \vert}^{2} {\int }_{t} {\vert {\int }_{z} {g}_{RX} ( z ) {g}_{TX} ( t - {kT}_{p} - {lT}_{s} - z ) dz \vert}^{2} dt$$

where (a) holds due to the fact that the integral over z yields the baseband pulse matched filter output, i.e., a raised cosine pulse shifted at the delay kTₚ+lTₛ and that the subsequent integral over t computes its energy E_{g} which remains invariant to the delay kTₚ+lTₛ. Given the noise variance σ² and and assuming without loss of generality that σ²=\sqrt{Eₛ}LE_{g}, the downlink beam SNR for each codeword is obtained as

$${γ}_{k} = \frac{{η}_{k}}{{σ}^{2}} = {f}_{comm}^{H} {H}_{comm} {f}_{k} . \qquad ( 5 )$$

Then, during A-BFT beam training of FIG. 2 the user transmits similar SSW frames to the AP using its uplink beamforming codebook so that the AP can compute the corresponding uplink beam SNRs to identify the best uplink beam to be used by the user. Each of these uplink SSW frames may contain feedback fields, allowing the user to share downlink beam SNRs γₖ back to the AP so that the AP can identify the best downlink beam to send a follow-up SSW Feedback frame to the user. The SSW Feedback frame informs the user of the best uplink beam for the uplink communication. Finally, the user uses the best uplink beam to send an SSW-ACK frame to the AP to confirm the completion of downlink and uplink beam training.

To enable integrated DTI communication and sensing, we are interested in designing a joint transceiver beamformer f_{T} and f_{R} such that the resulting downlink communication SNR

$${\vert {f}_{comm}^{H} {H}_{comm} {f}_{T} \vert}^{2} = {\vert {h}_{c}^{H} {f}_{T} \vert}^{2} \geq q \qquad ( 6 )$$

where h_{c} [symbol] H_{comm}^{H} f_{comm}, is above a threshold to guarantee the communication link quality. Following the standard specifications of existing DMG Wi-Fi devices, we assume that the AP is equipped with a hybrid architecture with L RF chains. Therefore, the transmit beamformer is formed as

$${f}_{T} = {\sum }_{k = 1}^{K} {w}_{k} {f}_{k} = Fw , {‖ w ‖}_{0} \leq L \qquad ( 7 )$$

where ∥w∥₀ denotes the [symbol] ₀-norm and F∈ [symbol] is a given codebook of size K. We emphasize that the DTI transmit beamforming vector f_{T} is based on exactly the same codebook F used during the BTI and constructed as a linear combination of at most L codewords. This allows for the calculation of downlink communication SNR for a chosen DTI transmit beamforming vector f_{T} using only the BTI feedback

$${\{ {γ}_{k} \}}_{k = 1}^{K} ,$$

thereby eliminating the need to know or estimate the communication channel H_{comm}, i.e.,

$${\vert {f}_{comm}^{H} {H}_{comm} {f}_{T} \vert}^{2} = {\vert {\sum }_{k} {w}_{k} {γ}_{k} \vert}^{2} = {\vert {γ}^{T} w \vert}^{2} , \qquad ( 8 )$$

where γ=[γ₁, . . . , γ_{K}]^{T} is the calculated BTI communication SNRs at the user that were fed back to AP during A-BFT. We further impose a power constraint on both transmit and (sensing) receive beamformers as

$${f}_{T}^{H} {f}_{T} = {P}_{T} , {f}_{R}^{H} {f}_{R} = {P}_{R} . \qquad ( 9 )$$

We aim to optimize the beamformers to match some desired array response for sensing while satisfying the communication SNR and power constraints. Let A_{T}=[a_{T}(θ₁), . . . , a_{T} (θ_{N}_{_{g}})]∈ [symbol] and A_{R}=[a_{R}(θ₁), . . . , a_{R} (θ_{N}_{_{g}})]∈ [symbol] denote matrices of array responses at pre-determined grid values over AoD and AoA angles. Then, we design the beamformers to minimize

$$‖ {D}_{T} {μ}_{T} - {A}_{T}^{H} {f}_{T} ‖$$

for the transmit side and

$$‖ {D}_{R} {μ}_{R} - {A}_{R}^{H} {f}_{R} ‖$$

for the receive side, where μ_{T}∈ [symbol] and μ_{R}∈ [symbol] are nominal desired responses, which can be chosen depending on some prior belief on potential objects. The auxiliary phase matrices D_{T} and D_{R} are diagonal matrices with [D]ₙₙ=e^{jφn} for unknown phase angles φₙ. These matrices are introduced to allow the beamformed response to match a phase-rotated version of the nominal response, since all phase-rotated versions will exhibit the same performance. Accounting for the constraints on downlink communication SNR (6), codebook (7) and power (9), the optimization is expressed as

$${minimize}_{{D}_{T} , {f}_{T} , w} ‖ {D}_{T} {μ}_{T} - {A}_{T}^{H} {f}_{T} ‖ \qquad ( 10 )$$

$$s . t . {f}_{T} = Fw \qquad ( 11 )$$

$${\vert {h}_{c}^{H} {f}_{T} \vert}^{2} \geq q \qquad ( 12 )$$

$${f}_{T}^{H} {f}_{T} = {P}_{T} \qquad ( 13 )$$

$${‖ w ‖}_{0} \leq L \qquad ( 14 )$$

for the transmitter side. Further, for the receiver side, we have

$${minimize}_{{D}_{R} , {f}_{R}} ‖ {D}_{R} {μ}_{R} - {A}_{R}^{H} {f}_{R} ‖ , s . t . {f}_{R}^{H} {f}_{R} = {P}_{R} . \qquad ( 15 )$$

The embodiments focus on designing the transmit beamformer and defer the discussion of the receive beamformer until the end of this section. Directly identifying the optimal codewords requires a combinatorial search through K_{L} configurations. For example, in 802.11ay settings with K=32 and L=4, this results in 35960 possibilities. Even with a pre-selected codebook, the problem remains nonconvex due to the auxiliary phase matrix D_{T} and the nonconvex constraints (12)-(13). In this section, a computationally efficient solution with two stages is disclosed. In Stage I, a two-way communication-sensing matching pursuit approach is introduced to select codewords, effectively defining the support of w. In Stage II, the resulting subproblem is addressed with an alternating minimization between D_{T} and beamforming weight w over the selected support.

### Two-way Matching Pursuit for Codeword Selection

The embodiments start by reformulating problem (1) into an equivalent form

$${minimize}_{{D}_{T} , w} ‖ {μ}_{T} - {D}_{T}^{H} {A}_{T}^{H} Fw ‖ \qquad ( 16 )$$

$$subject to {\vert {h}_{c}^{H} Fw \vert}^{2} \geq q , \qquad ( 17 )$$

$${w}^{H} {F}^{H} Fw = {P}_{T} \qquad ( 18 )$$

$${‖ w ‖}_{0} \leq L . \qquad ( 19 )$$

where the equivalence follows from the fact that D_{T} is a unitary matrix.

This, in some embodiments, is interpreted as a sparse recovery problem, where the objective is to approximate the desired array response μ_{T} using L atoms (i.e., column vectors) selected from a dictionary given by

$${D}_{T}^{H} {A}_{T}^{H} F .$$

Unlike conventional sparse recovery problems, however, problem (3.1) allows for flexibility in designing the dictionary by optimizing over the auxiliary diagonal phase matrix D_{T}. Additionally, the beamforming solution must satisfy constraints for the downlink communication SNR (17)) and power (18), in addition to approximating the target array response vector μ_{T}.

To this end, the disclosure proposes a two-way matching pursuit algorithm that chooses the codewords in the direction of either the communication or sensing. Like the classical OMP, the proposed algorithm selects the codewords from F iteratively by maximizing their inner product with a residual vector at each step. However, the key difference lies in how the residual vector is computed. Let F [symbol] ∈ [symbol] denote the matrix of selected codewords at the [symbol] -th step. At each step, the algorithm first solves the following optimization problem

$${minimize}_{w} {\vert {h}_{c}^{H} {F}_{ℓ} w \vert}^{2} , s . t . {w}^{H} {F}_{ℓ}^{H} {F}_{ℓ} w = {P}_{T} , \qquad ( 20 )$$

whose the closed-form solution is given by

$${\tilde{w}}_{ℓ}^{*} = \sqrt{{P}_{T}} \frac{{F}_{ℓ}^{†} {h}_{c}}{‖ {F}_{ℓ} {F}_{ℓ}^{†} {h}_{c} ‖}$$

with F^{†} [symbol] (F^{H}F)⁻¹F^{H} denoting the pseudo inverse of F. The optimal value of (20) serves as a feasibility check of whether a given selection of codewords [symbol] satisfies the communication SNR constraint (17). If it exceeds q, i.e.,

$${\vert {h}_{c}^{H} {F}_{ℓ} {\tilde{w}}_{ℓ}^{*} \vert}^{2} = {P}_{T} {‖ {F}_{ℓ} {F}_{ℓ}^{†} {h}_{c} ‖}^{2} \geq q \qquad ( 21 )$$

there exists a set of nonzero weights that would linearly combine the column vectors in [symbol] to yield a beamforming vector satisfying the communication constraint (17). Conversely, if

$${P}_{T} {‖ {F}_{ℓ} {F}_{ℓ}^{†} {h}_{c} ‖}^{2} < q ,$$

constraint (17) is violated for all beamformers that are written as a linear combination of the columns in [symbol] .

The proposed codeword selection strategy chooses subsequent codewords based on whether the feasibility condition (21) is satisfied. If condition (21) fails at step [symbol] , the next chosen codeword should be close to the direction of communication vector h_{c} to further enhance the downlink communication link. This is achieved by performing one more iteration of the classical OMP to approximate h_{c} using codewards drawn from a dictionary F, given that [symbol] <L columns [symbol] have been previously selected. This leads to the computation of a residual term r [symbol] =h_{c}− [symbol] [symbol] between the communication vector h_{c} and already identified codewords [symbol] where the weight for the L codewords is given by

$${\hat{w}}_{ℓ} = arg {min}_{w} ‖ {h}_{c} - {F}_{ℓ} w ‖ = {F}_{ℓ}^{†} {h}_{c} . \qquad ( 22 )$$

and the selection of the next codeword that maximizes the inner product between [symbol] and the remaining codewords f∈F/

[symbol]

$${f}_{ℓ + 1} = arg {max}_{f ∈ F / {F}_{ℓ}} \vert {r}_{ℓ}^{H} f \vert . \qquad ( 23 )$$

On the other hand, if condition (21) is satisfied at step [symbol] , the chosen codewords already meet the communication SNR constraint, and the next codeword should be selected to optimize the sensing performance. This is done by performing one more iteration of the OMP to find a sparse approximation of μ using an adaptive dictionary

$${D}_{T}^{H} {A}_{T}^{H} F ,$$

given that

$${D}_{T}^{H} {A}_{T}^{H} {F}_{ℓ}$$

have previously been selected. In this case, the iteration involves solving the following minimization

$$\{ {\hat{D}}_{ℓ} , {\hat{w}}_{ℓ} \} = arg {min}_{D , w} ‖ μ - {D}_{T}^{H} {A}_{T}^{H} {F}_{ℓ} w ‖ , \qquad ( 24 )$$

then computing the residual

$${r}_{ℓ} = μ - {\hat{D}}_{ℓ}^{H} {A}_{T}^{H} {F}_{ℓ} {\hat{w}}_{ℓ} ,$$

and finally selecting the next codeword according to

$${f}_{ℓ + 1} = arg {max}_{f ∈ F / {F}_{ℓ}} {max}_{{D}_{T}} \vert {r}_{ℓ}^{H} {D}_{T}^{H} {A}_{T}^{H} f \vert \qquad ( 25 )$$

As the proposed method either selects the codewords to enhance the downlink communication link (22)-(23), or to improve the sensing (24)-(25), The disclosure refers the proposed method as two-way matching pursuit. Finally, the new codeword is appended to the existing set of selected codewords as

$${F}_{ℓ + 1} = [ {F}_{ℓ} {f}_{ℓ + 1} ] \qquad ( 26 )$$

Optimization over D_{T} and for Selected Codewords

Given the selected codeword F_{L} from the two-way matching pursuit method, some embodiments simplify problem as follows

$${minimize}_{{D}_{T} , w} {‖ {μ}_{T} - {D}_{T}^{H} {A}_{T}^{H} {F}_{L} w ‖}^{2} \qquad ( 27 )$$

$$subject to {\vert {h}_{c}^{H} {F}_{L} w \vert}^{2} \geq q , \qquad ( 28 )$$

$${w}_{L}^{H} {F}_{L}^{H} {F}_{L} w = {P}_{T} , \qquad ( 29 )$$

where w∈ [symbol] . To address the nonconvex problem, a simple alternating minimization approach is considered. For a fixed w, the optimization over D_{T} leads to a closed-form solution given by

$${[ {D}_{T} ]}_{n n} = {e}^{j {ϕ}_{n}} , {ϕ}_{n} = {∠ [ {μ}^{H} {A}_{T}^{H} {F}_{L} w ]}_{n} , n = 1 , … , {N}_{g} . \qquad ( 30 )$$

On the other hand, with a fixed D_{T}, the optimization problem over w becomes a quadratic program with two quadratic constraints, which is known to exhibit strong duality. As a result, this problem is efficiently solved using Lagrange duality, leading to a closed-form solution (skipping the derivation details due to space limitations)

$$w = {( {Ξ}_{0} + {λ}_{1} {Ξ}_{1} + {λ}_{2} {Ξ}_{2} )}^{- 1} \tilde{μ} \qquad ( 31 )$$

where

$${Ξ}_{0} {=}^{Δ} {F}_{L}^{H} {A}_{T} {A}_{T}^{H} {F}_{L} , {Ξ}_{1} {=}^{Δ} {F}_{L}^{H} {h}_{c}^{H} {h}_{c} {F}_{L} , {Ξ}_{2} {=}^{Δ} {F}_{L}^{H} {F}_{L} , \tilde{μ} {=}^{Δ} {F}_{L}^{H} {A}_{T} {D}_{T} {μ}_{T} ,$$

and λ_{1/2} are Lagrange variables that can be determined using methods such as bisection. It alternates between (30) and (31) until convergence. It is noted that the same procedure, in some embodiments, is applied to optimize the receive beamforming problem in (15) and the OMP subproblem in (24) with appropriate modifications.

The alternating minimization procedure is always guaranteed to converge to a local solution since the objective is non-increasing at every step. As a result, the overall performance largely depends on the two-way matching pursuit codeword selection in Stage I. Operationally, the algorithm first selects codewords more aligned with the direction of _{c} for the first [symbol] ≤L iterations until condition (21) is satisfied. Afterward, the remaining L− [symbol] codewords are chosen to enhance the sensing performance. Regarding the computational complexity, the algorithm is significantly more efficient than the brute force method, requiring only L iterations instead of K_{L}. Furthermore, the per-iteration complexity remains relatively low, as it is dominated by the minimization in (22) or in (24).

### Applications of the Technology

The integration of communication and sensing functionalities within a single system, enabled by adaptive beamforming, has significant implications across various industries and applications. By leveraging shared hardware resources and optimized beamforming patterns, this technology provides enhanced efficiency, cost savings, and new capabilities in environments requiring simultaneous communication and environmental sensing. Key application areas include:

### Industrial Automation

In industrial settings, automation systems require precise environmental sensing to monitor machinery, detect objects on assembly lines, and ensure worker safety. Simultaneously, robust communication is needed to coordinate actions among robots, sensors, and control systems.

This technology enables real-time coordination by integrating sensing and communication, allowing robots and automated systems to detect and respond to their surroundings while exchanging critical data with centralized controllers or other devices. This technology offers flexible resource allocation through adaptive beamforming, which focuses sensing capabilities on high-priority areas like conveyor belts or hazardous zones without compromising communication reliability. Additionally, this technology enhances scalability in large-scale industrial setups by reducing the need for separate hardware installations, simplifying deployment and maintenance of automated operations.

### Smart Home Systems

Modern smart home systems incorporate a wide range of devices, from sensors and cameras to connected appliances and hubs. These systems rely on Wi-Fi communication to link devices and enable remote control while integrating environmental sensing to detect motion, monitor air quality, and track occupancy.

This technology enhances smart homes by enabling streamlined integration, where a single mmWave Wi-Fi system provides both high-speed communication for connected devices and environmental sensing for home automation and security. This technology improves sensing accuracy through optimized beamforming patterns that enable precise detection of occupancy or movement, allowing automated control of lighting, heating, and security functions based on real-time activity. Additionally, this technology enhances energy efficiency by sharing resources, reducing power consumption compared to maintaining separate communication and sensing devices.

Integrated communication and sensing systems are valuable in various environments requiring simultaneous functionality. In healthcare, such systems enable patient monitoring by tracking movements or vitals while ensuring secure communication between medical devices and staff. Retail and warehousing benefit from such systems by detecting inventory levels or tracking item locations while maintaining seamless communication with logistics networks. For public safety and security, such systems support real-time monitoring of public spaces for unusual activity or intrusions while maintaining reliable links for emergency response coordination. In smart cities, such systems help monitor traffic flow, detect accidents, and manage street lighting while facilitating data exchange with central control systems.

This technology offers key benefits across applications by enhancing cost efficiency through shared hardware for communication and sensing, reducing installation and maintenance expenses. This technology's adaptability is enabled by real-time beamforming optimization, allowing dynamic adjustments to changing environmental and operational conditions. By integrating sensing and communication into a single system, the technology reduces complexity, eliminating the need for separate devices and simplifying deployment and operation. Additionally, joint optimization ensures enhanced performance, meeting both communication and sensing objectives without compromising reliability. By addressing the challenges of integration, this technology serves as a versatile platform for innovation across diverse industries, making the technology a cornerstone for future advancements in connected and automated systems.

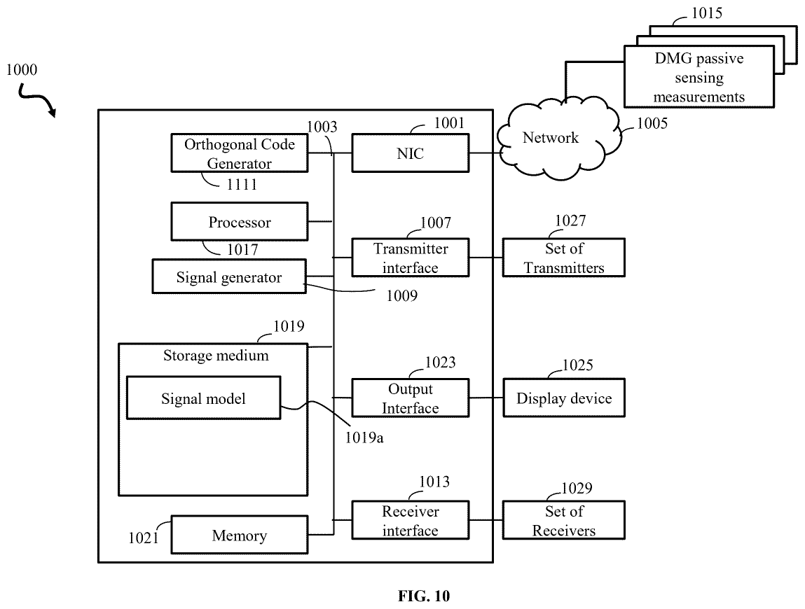

FIG. 10 illustrates a block diagram of a computing system 1000 for implementing the DMG sensing, according to an embodiment of the present disclosure.

The computing system 1000, in some embodiments, has a number of interfaces connecting the computing system 1000 with other systems and devices. To that end, the computing system 1000 is equivalent to the system 102 or the system 104 illustrated in FIG. 1. The computing system 1000 includes a network interface controller (NIC) 1001 that is adapted to connect the computing system 1000 through a bus 1003 to a network 1005 connecting the computing system 1000 with sensing devices. The computing system 1000 includes a transmitter interface 1007 configured to command a set of transmitters 1027 to transmit packets in a radio frequency (RF) band over a sequence of pulse repetition intervals (PRI). The transmitter interface 1007 is in communication with a signal generator 1009 that generates the packets.

Further, an orthogonal code generator 1111 is used to generate different orthogonal codes which are multiplied with the packets associated with each transmitter of the set of transmitters 1027. The computing system 1000 is connected to a set of receivers 1029 via a receiver interface 1013. The set of receivers 1029 is configured to collect measurements 1015 of the scene, through the network 1005. The measurements 1015 of the scene are sampled in a time-frequency domain within an intermediate frequency (IF) bandwidth to which reflection of the transmitted FMCW is shifted by mixing with a copy of the packets.

Further, the computing system 1000 includes a processor 1017 (equivalent to the processor 202 shown in FIG. 2) configured to execute instructions stored in a storage medium 1019 as well as a memory 1021 (equivalent to the memory 201 shown in FIG. 2). The processor 1017, in some embodiments, is a single core processor, a multi-core processor, a computing cluster, or any number of other configurations. The memory 1021, in some embodiments, includes random access memory (RAM), read only memory (ROM), flash memory, or any other suitable memory systems. The storage medium 1019 may include random access memory (RAM), read only memory (ROM), flash memory, or any other suitable memory systems. The processor 1017, in some embodiments, is connected through the bus 1003 to one or more input and/or output (I/O) devices.

The storage medium 1019 is configured to store a signal model 1019a that is configured to jointly evaluate the measurements and beacon transmissions to determine the parameters of an object. In an embodiment, the signal model 1019a explains the measurements for different quantized angles at a range-doppler bin as a sum of a binary classified Kronecker product of an ego-transmitter steering vector and an ego-receiver steering vector modifying an unknown angle and a Kronecker product of an interfering-transmitter steering vector and the ego-receiver steering vector modifying the unknown angle. Alternatively, in some embodiments, the signal model 1019a is configured to perform a hypothesis occupancy testing to identify the different parameters of the object as values of an occupancy map with multiple dimensions.

In an embodiment, the processor 1017 is further configured to evaluate measurements of different grids of the occupancy map independently from each other, wherein for evaluating the measurements of the grid, the processor 1017 is further configured to evaluates the presence of the hypothetical transmitter for each of different values of the first unknown angle to explain the measurements of the segment for different values of the second unknown angle. In some other embodiments, the processor 1017 is further configured to evaluate the measurements of the grid statistically over multiple pulse repetition intervals using a generalized likelihood ratio test (GLRT).

The computing system 1000 includes an output interface 1023 configured to output the parameters associated with the object. The parameters include at least one of a velocity, an angle, and a distance to the object. The output interface 1023, in some embodiments, outputs the parameters on a display device 1025, store the parameters into a storage medium and/or transmit the parameters over the network 1005. For example, the computing system 1000, in some embodiments, is linked through the bus 1003 to a display interface adapted to connect the computing system 1000 to the display device 1025, such as a computer monitor, camera, television, projector, or mobile device, among others. Additionally, in some embodiments, the computing system 1000 is connected to an application interface adapted to connect the computing system 1000 to equipment for performing various tasks.

The description provides exemplary embodiments only, and is not intended to limit the scope, applicability, or configuration of the disclosure. Rather, the following description of the exemplary embodiments provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus”, in some embodiments, encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and the computer program can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program, is some embodiments, is deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit is configured to receive instructions and data from a read only memory or a random access memory or both. The essential elements of a computer are a central processing unit for performing or executing instructions and one or more memory devices for storing instructions and data.

Generally, a computer also includes, or be operatively coupled to receive data from or transfer data to, or both, one or more mass storage devices for storing data, e.g., magnetic, magneto optical disks, or optical disks. However, a computer may not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship with each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

### LIST OF ABBREVIATIONS

AP—Access Point
STA—Station
BTI—Beacon Transmission Interval
A-BFT—Association Beamforming Training
ATI—Announcement Transmission Interval
DTI—Data Transmission Interval
SSW—Sector Sweep
SP—Service Periods
CBAP—Contention Based Access Periods

We claim:

1. A system for integrated mmWave communication and sensing, comprising: an antenna array configured to transmit and receive directional signals via a number of available RF chains; a memory configured to store a predefined codebook comprising a plurality of beamforming patterns; and a processor coupled with instruction stored in the memory that, when executed by the processor, cause the system to:
send and receive beamforming patterns from the predefined codebook during beam training intervals, and compute beamforming qualities for one or multiple devices in communication with the system;
select multiple beamforming patterns from the predefined codebook according to the number of available RF chains having the beamforming qualities, individually or combined, sufficient to satisfy a communication criterion including a minimum data transmission threshold for communication with the devices;
determine weights for a combination of the selected beamforming patterns optimized for a sensing criterion while maintaining the communication criterion to produce an optimized beamforming pattern; and
configure the antenna array to utilize the optimized beamforming pattern for integrated communication and sensing while adhering to power and hardware constraints.

2. The system of claim 1, wherein the sensing criterion includes minimizing array response mismatch between a desired sensing beam pattern and an actual beam pattern.

3. The system of claim 1, wherein the sensing criterion includes maximizing sensing coverage across a specified angular range.

4. The system of claim 1, wherein the sensing criterion includes enhancing angular resolution for improved object localization accuracy.

5. The system of claim 1, wherein the sensing criterion includes suppressing side lobe interference to reduce unintended signal interference.

6. The system of claim 1, wherein the sensing criterion includes maximizing a probability of object detection while maintaining a given probability of a false alarm.

7. The system of claim 1, wherein the sensing criterion includes improving doppler sensitivity for detecting and tracking moving objects.

8. The system of claim 1, wherein the processor dynamically selects the beamforming patterns based on real-time feedback obtained during beam training intervals, including beacon transmission intervals (BTI) and association beamforming training (A-BFT) intervals, to optimize both communication and sensing performance.

9. The system of claim 1, wherein the processor implements a two-stage optimization process and is configured to:
select the multiple beamforming patterns from the predefined codebook that meet a minimum communication signal-to-noise ratio (SNR) threshold; and
refine the selected beamforming patterns to enhance sensing performance based on at least one predefined sensing criterion including maximizing coverage, improving angular resolution, or suppressing side-lobe interference.

10. The system of claim 1, wherein the processor adjusts an auxiliary phase matrix to align an actual array response of the antenna array with a desired sensing array response, thereby improving accuracy and reliability of the integrated sensing function.

11. The system of claim 1, wherein the antenna array is configured with a hybrid beamforming architecture that utilizes a limited number of radio frequency (RF) chains to efficiently balance communication and sensing objectives while minimizing hardware complexity and power consumption.

12. The system of claim 1, wherein a two-way matching pursuit followed by an alternating optimization to select codewords by alternating between maximizing SNR and minimizing sensing array response mismatch.

13. The system of claim 12, wherein the alternating optimization iteratively adjusts beamforming weights and an auxiliary phase matrix to ensure adherence to communication SNR and power constraints.

14. The system of claim 12, wherein the alternating optimization dynamically prioritizes sensing objectives, including improving angular resolution and suppressing side lobe interference, based on environmental conditions.

15. The system of claim 1, wherein the processor dynamically adapts the beamforming patterns to monitor industrial machinery for anomalies while simultaneously transmitting operational data to a central control system.

16. The system of claim 1, wherein the sensing functionality is configured to detect objects or materials on a conveyor belt, and the communication functionality provides real-time feedback to robotic manipulators.

17. The system of claim 1, wherein the sensing functionality is used to detect human occupancy or movement, and the communication functionality supports remote control of smart devices including one or a combination of lighting, heating, and security systems.

18. The system of claim 1, wherein the processor dynamically adjusts the beamforming patterns to detect intrusions or unusual activity while maintaining communication with connected cameras and alarms.

19. A method for integrated mmWave communication and sensing, wherein the method uses a processor coupled with stored instructions implementing the method, wherein the instructions, when executed by the processor carry out steps of the method, comprising:
sending and receiving beamforming patterns from a codebook of beamforming patterns during beam training intervals and computing beamforming qualities for one or more devices in communication with a system;
selecting multiple beamforming patterns from the codebook based on a number of available RF chains and the beamforming qualities, wherein the selected patterns satisfy a communication criterion including a minimum data transmission threshold for communication with the devices;
determining weights for a linear combination of the selected beamforming patterns, the linear combination being optimized for a sensing criterion while maintaining the communication criterion;
producing an optimized beamforming pattern based on the linear combination; and
performing integrated communication and sensing using an antenna array configured to utilize the optimized beamforming pattern.

20. A non-transitory computer-readable storage medium embodied thereon a program executable by a processor for performing a method for perceiving an object in a scene, the method comprising:
sending and receiving beamforming patterns from a codebook of beamforming patterns during beam training intervals and computing beamforming qualities for one or more devices in communication with a system;
selecting multiple beamforming patterns from the codebook based on a number of available RF chains and the beamforming qualities, wherein the selected patterns satisfy a communication criterion including a minimum data transmission threshold for communication with the devices;
determining weights for a linear combination of the selected beamforming patterns, the linear combination being optimized for a sensing criterion while maintaining the communication criterion;
producing an optimized beamforming pattern based on the linear combination; and
performing integrated communication and sensing using an antenna array configured to utilize the optimized beamforming pattern.
